(19) United States
(12) Patent Application Publication
(10) Pub. No.: US 2011/0066263 A1
(43) Pub. Date: Mar. 17, 2011

(54) AUDIO PLAYBACK DEVICE AND AUDIO PLAYBACK METHOD

(75) Inventor: Daisuke Iwai, Tokyo (JP)

(73) Assignee: KABUSHIKI KAISHA TOSHIBA, Tokyo (JP)

(21) Appl. No.: 12/727,584

(22) Filed: Mar. 19, 2010

(30) Foreign Application Priority Data
Sep. 17, 2009 (JP) 2009-215794

(51) Int. Cl. G06F 17/00

(52) U.S. Cl. 700/94

(57) ABSTRACT

An audio playback device has an importance degree calculator configured to set an importance degree of a digital audio signal based on a playback sound volume of the digital audio signal, and a frequency converter configured to convert a sampling frequency of the digital audio signal to a predetermined frequency with sound quality and power consumption according to the importance degree.

### CROSS REFERENCE TO RELATED APPLICATIONS

This application is based upon and claims the benefit of priority from the prior Japanese Patent Application No. 2009-215794 filed on Sep. 17, 2009, the entire contents of which are incorporated herein by reference.

### BACKGROUND OF THE INVENTION

1. Field of the Invention

The invention relates to an audio playback device and an audio playback method for converting a sampling frequency of a digital audio signal to reproduce the digital audio signal.

2. Related Art

In audio playback devices, a sampling frequency of a digital audio signal may be converted. For example, some recent cellular phones have a function to reproduce both a TV audio and an incoming call alert when there is an incoming call during watching a TV broadcast. When a plurality of digital audio signals are reproduced, it is general to convert the digital audio signals to analog audio signals after mixing the plurality of digital audio signals (for example, JP-A No, 2009-4848(Kokai)). In order to mix the plurality of digital audio signals, the sampling frequency of each digital audio signal has to be the same. Therefore, before mixing, it is necessary to convert the sampling frequency of the digital audio signals to a constant frequency.

For an audio playback device integrated on mobile devices driven by a battery such as the cellular phone, low power consumption is strongly required. However, it requires a large amount of operation to perform frequency conversion without lowering a sound quality, which may increase the power consumption. On the other hand, if the frequency conversion is performed with small amount of operation, the sound quality may be lowered. Thus, the conventional audio playback device cannot satisfy both of the high sound quality and the low power consumption.

### SUMMARY

According to one aspect of the present invention, an audio playback device comprising: an importance degree calculator configured to set an importance degree of a digital audio signal based on a playback sound volume of the digital audio signal; and a frequency converter configured to convert a sampling frequency of the digital audio signal to a predetermined frequency with sound quality and power consumption according to the importance degree.

According to the other aspect of the present invention, an audio playback device comprising: a plurality of importance degree calculators corresponding to a plurality of digital audio signals each of which is configured to set an importance degree of each of the plurality of digital audio signals based on a playback sound volume of each of the plurality of digital audio signals and a number of the plurality of digital audio signals; and a plurality of frequency converters corresponding to the plurality of digital audio signals each of which is configured to convert a sampling frequency of corresponding one of the plurality of digital audio signals to a predetermined frequency with sound quality and power consumption according to the importance degree.

According to the other aspect of the present invention, an audio playback method comprising: setting an importance degree of a digital audio signal based on a playback sound volume of the digital audio signal; and converting a sampling frequency of the digital audio signal to a predetermined frequency with sound quality and power consumption according to the importance degree.

### BRIEF DESCRIPTION OF THE DRAWINGS

FIG. 1 is a block diagram showing a schematic configuration of an audio playback device according to a first embodiment of the present invention.

FIG. 2 is a block diagram showing an example of an internal configuration of a frequency converter 2a.

FIG. 3 is a block diagram showing an example of an internal configuration of a FIR filter 12.

FIG. 4 is a frequency characteristic showing a difference between a filter with a large number of taps and that with a small number of taps.

FIG. 5 is a table summarizing a difference between the filter with a large number of taps and that with a small number of taps.

FIG. 6 is a block diagram showing an example of an internal configuration of a mixer 3.

FIG. 7 is a flowchart showing an example of an operation to set the importance degree performed by an importance degree calculator 33.

FIG. 8 is another flowchart showing an example of an operation to set the importance degree performed by the importance degree calculator 33.

FIG. 9 is a block diagram showing another example of an internal configuration of the FIR filter 12a.

FIG. 10 is a block diagram showing a schematic configuration of an audio playback device according to a third embodiment of the present invention.

### DETAILED DESCRIPTION OF THE INVENTION

Hereinafter, audio playback devices and audio playback methods according to embodiments of the present invention will be specifically explained with reference to accompanying drawings.

### First Embodiment

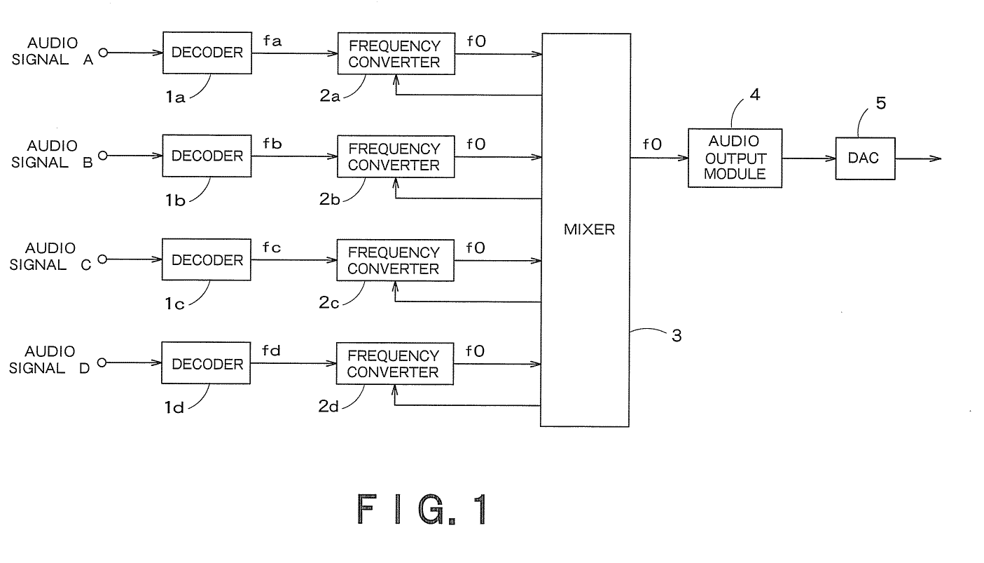

FIG. 1 is a block diagram showing a schematic configuration of an audio playback device according to a first embodiment of the present invention. The audio playback device has decoders 1a to 1d, frequency converters 2a to 2d, a mixer 3, an audio output module 4 and a DAC (Digital to Analog Converter) 5. When a plurality of digital audio signals (hereinafter, referred to as audio signals) are inputted at the same time, the audio playback device takes it into consideration to mix these audio signals to reproduce them at the same time. The present embodiment shows an example where four audio signals “A” to “D” can be reproduced at the same time at the maximum. However, four audio signals “A” to “D” are not always inputted and the number of the inputted audio signals can be two or more. Here, the audio signals “A” to “D” are compressed in advance to be inputted to the audio playback device.

The decoders 1a to 1d decode the inputted audio signals “A” to “D”, respectively. The sampling frequencies of the decoded audio signals “A” to “D” are fa to fd respectively, and these sampling frequencies are not necessarily the same. The frequency converters 2a to 2d convert the sampling frequencies of the decoded audio signals “A” to “D” to a frequency f0, respectively. In more detail, the frequency converters 2a to 2d perform frequency conversion of the digital audio signals so that each of audio signals “A” to “D” is audio-reproduced with a sound quality depending on importance degrees of the audio signals “A” to “D” and that power consumption depends on the importance degrees. The mixer 3 mixes the audio signals “A” to “D” with a predetermined ratio and sets the importance degrees of the audio signals “A” to “D”.

The audio output module 4 converts the mixed audio signal having a plurality of bits to a serial signal and divides the serial signal in time series to output it to the DAC 5 with a clock signal (not shown). The DAC 5 converts the audio signal to an analog audio signal. Then, audio processing is performed in the analog signal if needed, and the audio is outputted from speakers or earphones (not shown).

For example, among the audio playback device of FIG. 1, the decoders 1a to 1d, the frequency converters 2a to 2d, the mixer 3 and the audio output module 4 can be integrated in a semiconductor chip and the DAC 5 can be integrated in another semiconductor chip.

When a plurality of audio signals are reproduced, all of the audio signals are not always reproduced with the same sound volume. For example, there is an incoming call during watching a TV broadcast, it is normal that an incoming call alert is reproduced with a large sound volume and that a TV audio is reproduced with a small sound volume. In this case, the incoming call alert has to be reproduced with a high sound quality. However, it is acceptable to sacrifice the sound quality of the TV audio in some degree in order to reduce the power consumption.

Therefore, in the present embodiment, the frequency converters 2a to 2d perform the frequency conversion of the audio signal with the high sound quality when the importance degree of the audio signal is high, while perform the frequency conversion of the audio signal with sacrificing the audio quality to target reducing the power consumption.

Hereinafter, the frequency converters 2a to 2d and the mixer 3 will mainly be explained, which are main characteristic features of the present embodiment.

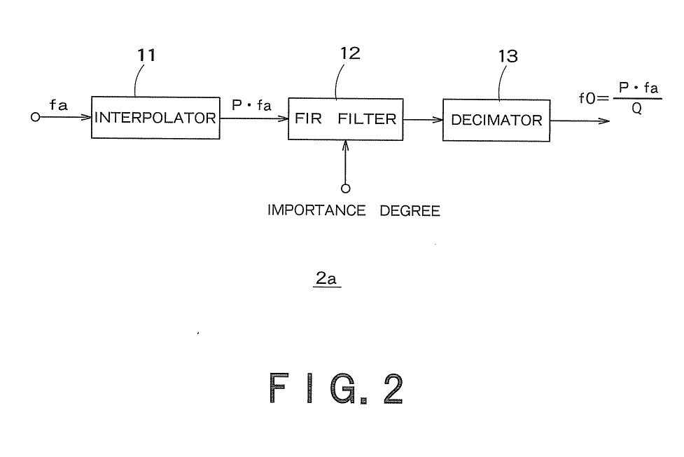

FIG. 2 is a block diagram showing an example of an internal configuration of the frequency converter 2a. Note that because the internal configurations of the frequency converters 2a to 2d are the same, the frequency converter 2a will be representatively explained.

The frequency converter 2a has an interpolator 11, an FIR (Finite Impulse Response) filter 12 and a decimator 13. The Frequency converter 2a intends to convert a sampling frequency fa of the audio signal “A” to a frequency f0.

The interpolator 11 periodically inserts a sample data (for example, “0”) into the audio signal “A” to set the sampling frequency to be “P*fa” (P is an integer). The FIR filter 12 performs LPF (Low Pass Filter) processing to remove alias from the audio signal “A” into which the sample data is inserted. The processing of the FIR filter 12 affects the power consumption and the sound quality of the frequency-converted audio signal “A” drastically, which will be explained below. The decimator 13 decimates data from the audio signal “A” having the sampling frequency “P*fa” to set the sampling frequency to be “P*fa/Q” (Q is an integer).

Above “P” and “Q” are set so that “P*fa/Q” coincides with f0. For example, in order to convert the sampling frequency fa of 44.1 kHz to the frequency f0 of 48 kHz, “P” and “Q” are set to be “160” and “147”, respectively.

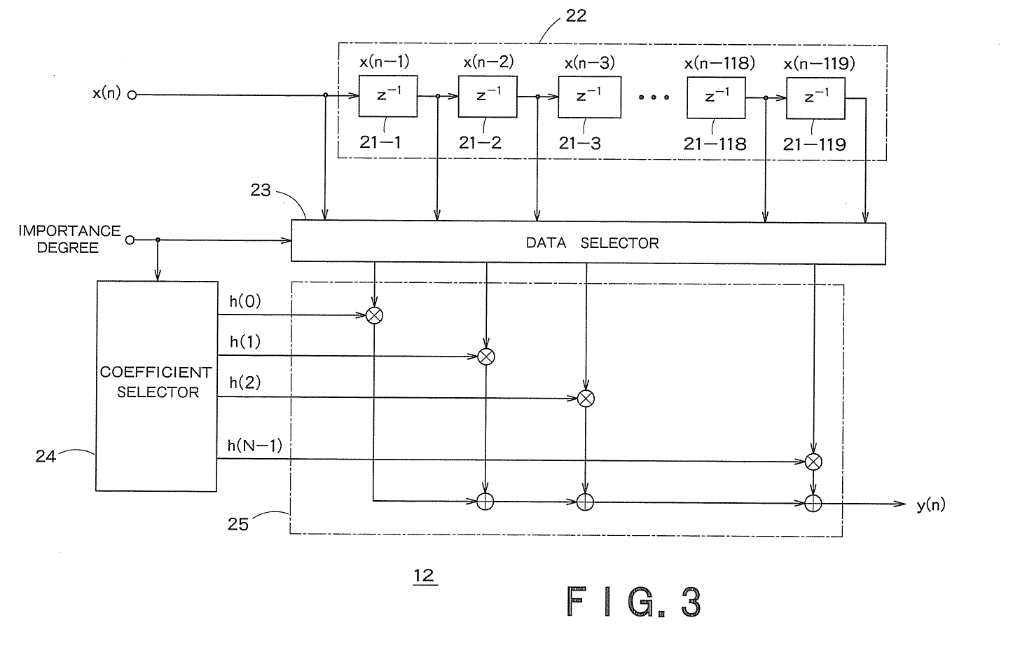

Next, processing operations of the FIR filter 12 will be explained in detail. FIG. 3 is a block diagram showing an example of an internal configuration of the FIR filter 12. The FIR filter 12 has a delaying buffer 22 with “119” delaying modules 21-1 to 21-119, a data selector 23, a coefficient selector 24 and an operator 25.

The delaying buffer 22 is a RAM (random access memory) which delays the audio signal “A” to write the data of audio signal “A” in each of the delaying modules 21-1 to 21-119. In FIG. 3 or the like, x(n) expresses the n-th data of the audio signal “A” inputted to the FIR filter 12. The data has “32” bits, for example. Therefore, each of the delaying modules 21-1 to 21-119 delays the data of “32” bits to transfer the delayed data by turns.

The data selector 23 selects “N−1” data stored in the delaying modules 21-1 to 21-119 according an importance degree of the audio signal “A” set by the mixer 3 to apply the selected data to the operator 25. Here, the importance degree is a value indicative of one of “high”, “middle” and “low”, for example. The setting way of the importance degree will be explained below. In the present embodiment, the value of “N” is “120” when the importance degree is “high”, “60” when the importance degree is “middle” and “20” when the importance degree is “low”. In other word, the data selector 23 selects “119” data stored in the delaying modules 21-1 to 21-119 when the importance degree is “high”, selects “59” data stored in the delaying modules 21-1 to 21-59 when the importance degree is “middle” and selects “19” data stored in the delaying modules 21-1 to 21-19 when the importance degree is “low” to apply the selected data to the operator 25.

The coefficient selector 24 selects “N” filter coefficients to apply the selected filter coefficients to the operator 25 according to the importance degree. More specifically, the coefficient selector 24 selects “120” coefficients for a filter with a large number of taps, “60” coefficients for a filter with a middle number of taps and “20” coefficients for a filter with a small number of taps to apply the selected filter coefficients to the operator 25. These coefficients are predetermined constants (for example, 32 bits) and stored in the ROM (not shown) in the coefficient selector 24 in advance.

The operator 25 performs an operation of following equation (1) to output the audio signal “A” whose alias is removed.

$$y ( n ) = {\sum }_{i = 0}^{N - 1} h ( i ) \cdot x ( n - 1 ) \qquad ( 1 )$$

Here, y(n) expresses n-th data of the audio signal “A” outputted from the FIR filter 12, h(i) expresses the filter coefficient applied from the coefficient selector 24. Furthermore, “N” is a value determined according to the importance degree, as mentioned above.

The FIR filter 12 performs filtering processing with a large number of taps of “120” taps using all of “119” data x(n−1) to x(n−119) stored in the delaying buffer 22 and n-th data x(n) when the importance degree is “high”. The FIR filter 12 performs filtering processing with a middle number of taps of “60” taps using “59” data x(n−1) to x(n−59) stored in the delaying buffer 22 and n-th data x(n) when the importance degree is “middle”. The FIR filter 12 performs filtering processing with a small number of taps of “20” taps using “19” data x(n−1) to x(n−19) stored in the delaying buffer 22 and n-th data x(n) when the importance degree is “low”.

When the operator 25 is implemented by software, y(n) of the above equation (1) can be calculated by performing “N” times of multiplications and (N−1) additions according to the importance degree. On the other hand, when the operator 25 is implemented by hardware, y(n) of the above equation (1) can be calculated by providing a plurality of multipliers and adders and (N−1) RAM for delaying modules and performing “N” times of multiplications and (N−1) additions according to the importance degree. Or, “120” multipliers and “119” adders can be provided in advance, and “N” multipliers and (N−1) adders operates according to the importance degree to calculate y(n).

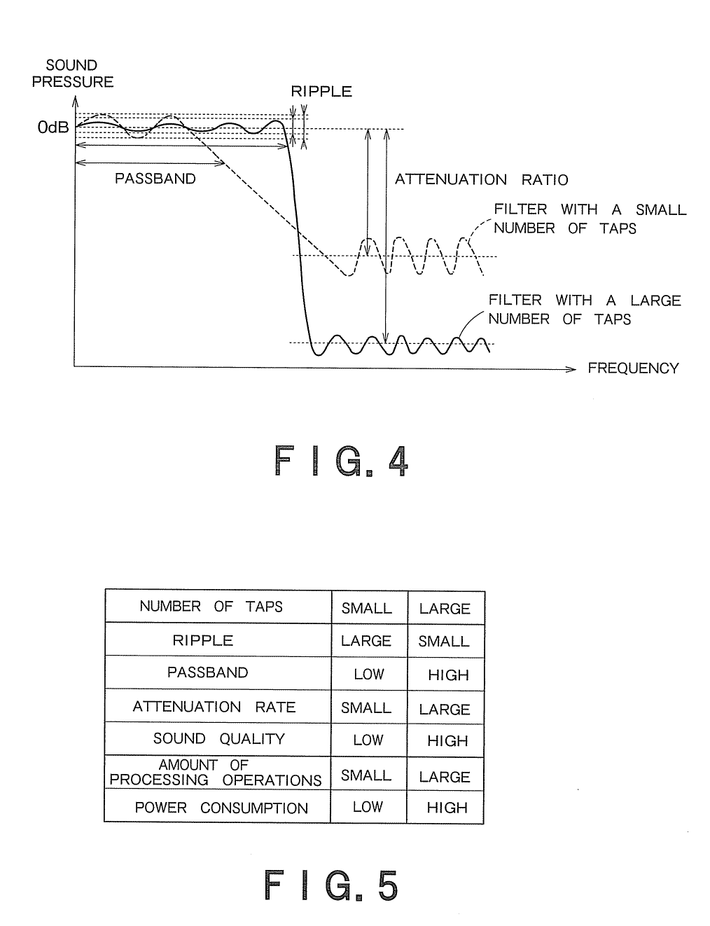

FIG. 4 is a frequency characteristic showing a difference between the filter with a large number of taps and that with a small number of taps. The solid line expresses a frequency characteristic of the filter with a large number of taps and the dashed line expresses a frequency characteristic of the filter with a small number of taps. Furthermore, FIG. 5 is a table summarizing a difference between the filter with a large number of taps and that with a small number of taps.

As shown in FIG. 4 and FIG. 5, as the number of the taps is larger, the ripple indicative of a fluctuation of the sound pressure is smaller. Therefore, the filter with a large number of taps can reproduce the audio signal with a stable sound volume independent of the pitch of the sound. Furthermore, as the number of the taps is larger, the pass band is higher. Therefore, the filter with a large number of taps can reproduce the sound with higher pitch. In addition, as the number of the taps is larger, the attenuation ratio is larger. Therefore, there is a lower noise in the audio signal processed by the filter with a large number of taps. As a result, as the number of the taps is larger, the frequency conversion can be performed with the higher sound quality.

Furthermore, as the number of the taps is smaller, the amount of the operation processing is smaller. As the number of the taps is smaller, the value of above “N” is smaller. Therefore in a case of software processing, the number of multiplications and additions is smaller, and in a case of hardware processing, the number of performing multiplying and adding operation is smaller. As a result, as the number of the taps is smaller, the frequency conversion can be performed with the lower power consumption.

As described above, as the importance degree is higher, the frequency converter 2a uses a larger number of data of audio signal “A”, thereby performing frequency conversion with the higher sound quality. On the other hand, as the importance degree is lower, the frequency converter 2a uses a smaller number of data of audio signal “A”, thereby performing frequency conversion with the lower power consumption.

Note that the configuration of the FIR filter 12 mentioned above is only an example and a various modification can be conceivable. For example, in order to reproduce the audio signal with the higher sound quality, the delaying buffer 22 can store more than “120” data of the audio signal and in order to reduce the power consumption or hardware volume, the delaying buffer 22 can store less data. Furthermore, the importance degree can be divided into not only three stages, namely, “high”, “middle” and “low”, but into more stages to control the sound quality and the power consumption in more finely.

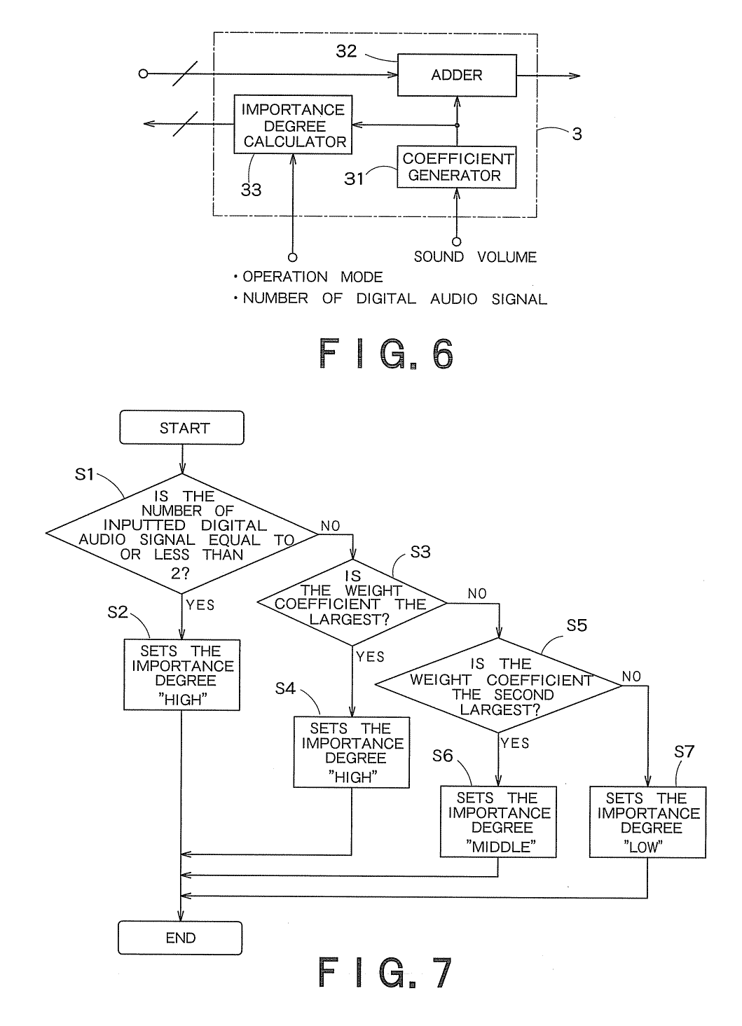

Then, the mixer 3 will be explained. FIG. 6 is a block diagram showing an example of an internal configuration of the mixer 3. The mixer 3 has a coefficient generator 31, an adder 32 and an importance degree calculator 33.

The coefficient generator 31 generates weight coefficients Ka to Kd for each of the audio signals “A” to “D” according to the playback sound volume of each of the audio signals “A” to “D” inputted from outside. The playback sound volume can be set by user of the audio playback device or can be set automatically, for example, when there is an incoming call during watching a TV broadcast, the sound volume of the TV broadcast is lowered. As the playback sound volume is larger, the coefficient generator 31 sets the weight coefficient larger.

The audio signals “A” to “D” whose sampling frequencies are unified to be f0 are inputted to the adder 32. Then, the adder 32 adds the audio signals “A” to “D” weighted by the weight coefficients Ka to Kd respectively to output a mixed audio signal. Thus, by adding the audio signals “A” to “D” weighted by weight coefficients Ka to Kd, the audio signals are mixed with a ratio according to the playback sound volume of each of the audio signals “A” to “D”.

The importance degree calculator 33 sets the importance degree of each audio signal based on the number of the inputted audio signals and the weighted coefficients. Furthermore, the importance degree calculator 33 can set the importance degree in consideration of the operation mode. Here, the operation mode means a parameter defining the power consumption of the entire of the audio playback device. For example, the user can select one of “high sound quality mode” which emphasizes a sound quality and “low power consumption mode” which emphasizes reducing the power consumption.

FIG. 7 is a flowchart showing an example of an operation to set the importance degree performed by the importance degree calculator 33. FIG. 7 shows an example where the importance degree is set based on the number of the audio signals and the weight coefficients.

When the number of the inputted audio signals is equal to or less than two (YES of Step S1), the importance degree calculator 33 sets all the importance degrees to be “high” regardless of the weight coefficient (Step S2). This is because when the number of the inputted audio signals is small, the total amount of the operations is small, and even if the FIR filter 12 performs the filtering processing with a large number of taps, the power consumption is not so large. On the other hand, the number of the inputted audio signals is equal to or more than three (No of Step S1), the importance degree calculator 33 sets the importance degree of the audio signal having the largest weight coefficient to be “high” (Yes of Step S3, Step S4), that having the second largest weight coefficient to be “middle” (Yes of Step S5, S6), that having the other weight coefficient to be “low” (Step S7), respectively.

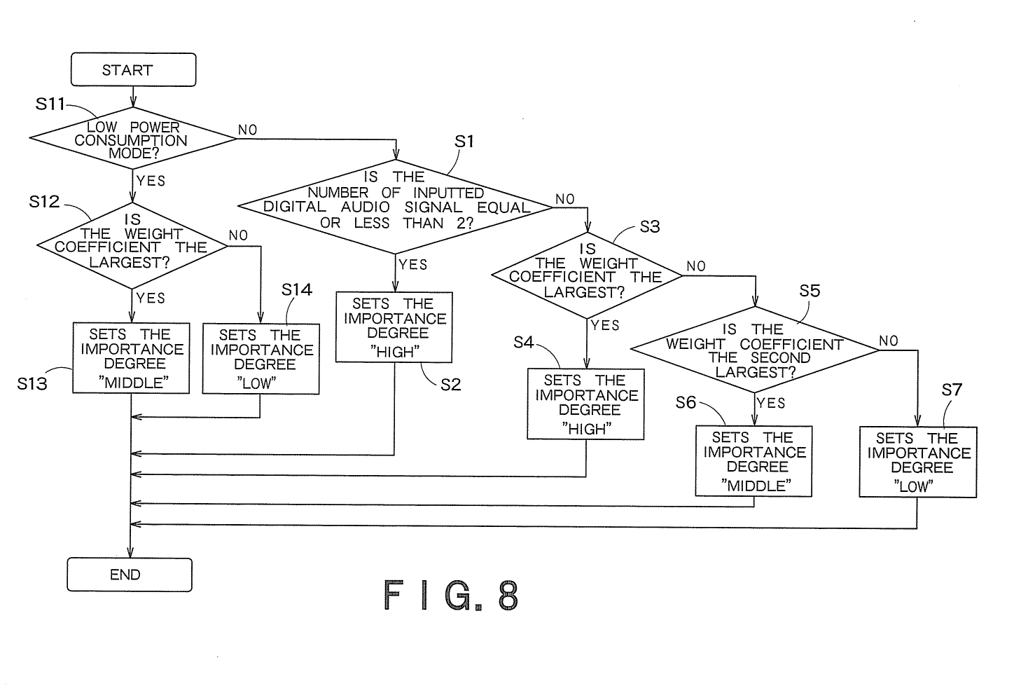

FIG. 8 is another flowchart showing an example of an operation to set the importance degree performed by the importance degree calculator 33. FIG. 8 shows an example where the importance degree is set in consideration of the operation mode in addition to the number of the inputted audio signals and the weight coefficient.

When the operation mode is the low power consumption mode (Yes of Step S11), in order to reduce the power consumption, the importance degree calculator 33 sets the importance degree of the audio signal having the largest weight coefficient to be “middle” (Yes of Step S12, Step S13) and that having the other weight coefficient to be “low” (Step S14), respectively. When the operation mode is the other one (No of Step S11), the importance degree is set similar to FIG. 7.

In the examples of FIG. 7 and FIG. 8 described above, as the weight coefficient is larger, the importance degree is set to be higher. Furthermore, as the sound volume is larger, the coefficient generator 31 sets the weight coefficient to be higher. As a result, as the sound volume is larger, the importance degree is set higher. As described in the explanation of the frequency converter 2a, when the importance degree is high, the frequency converters 2a to 2d perform the frequency conversion with the high sound quality and when the importance degree is low, the frequency converters 2a to 2d perform the frequency conversion with the low sound quality and the low power consumption. Therefore, well-heard audio signal with large sound volume can be reproduced with keeping the high sound quality, and the power consumption can be reduced by lowering the sound quality of not well-heard audio signal with small sound volume.

FIG. 7 and FIG. 8 are only an example, respectively. The importance degree can be set in accordance with the other parameters, for example, the transfer rate of the audio source and the number of channels can be taken into consideration.

As stated above, in the first embodiment, the importance degree is set based on the number of the inputted audio signals and the sound volume, and the number of the data (the number of the taps) used for frequency conversion is switched according to the importance degree. Therefore, when the importance degree of the audio signal is high, the frequency conversion can be performed with the high sound quality, and when the importance degree of the audio signal is low, the frequency conversion can be performed with the low power consumption. As a result, when a plurality of audio signals are mixed to be reproduced at the same time, the sound quality of well-heard audio signal is kept high and the power consumption of the entire of the audio reproduce device can be reduced.

### Second Embodiment

In the first embodiment described above, the frequency conversion is performed by switching the number of taps used for frequency conversion. On the other hand, in a second embodiment, which will be explained below, the internal configuration of the FIR filter 12 is different and the number of the bits is switched according to the importance degree.

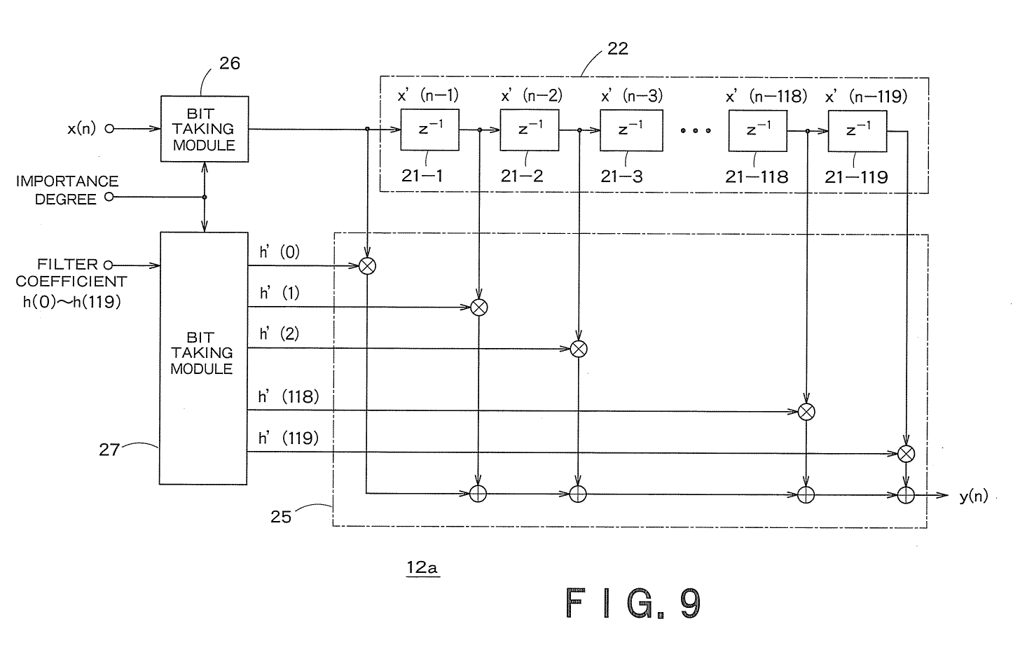

FIG. 9 is a block diagram showing another example of the internal configuration of the FIR filter 12a. The FIR filter 12a of FIG. 9 has first and second bit taking modules 26 and 27 and does not have the data selector 23 and the coefficient selector 24, which is a difference from the FIR filter 12 of FIG. 3.

The first bit taking module 26 takes all of or a part of the bits from the audio signal “A” according to the importance degree. For example, in a case where the audio signal “A” is a digital signal of “32” bits, the first bit taking module 26 takes all of the “32” bits of the audio signal “A” when the importance degree is “high”, takes upper “16” bits when the importance degree is “middle” and takes upper “8” bits when the importance degree is “low”, respectively. The delaying module 21-1 to 21-119 can store the data of “32” bits at the maximum. However, in the present embodiment, the data having the number of taken bits is stored. In FIG. 9 and the following explanation, the data of the taken audio signal “A” is expressed such as x′(0).

Thus, each of the delaying modules 21-1 to 21-119 of FIG. 3 always stores data of “32” bits regardless of the importance degree, while each of the delaying modules 21-1 to 21-119 of FIG. 9 stores data of different bits according to the importance degree.

The second bit taking module 27 take all of or a part of the bits from filter coefficients h(0) to h(N−1) stored in the ROM (not shown) used for LPF processing according to the importance degree. For example, in a case where the filter coefficients h(0) to h(N−1) are digital signals of “32” bits, respectively, the second bit taking module 27 takes all of the “32” bits when the importance degree is “high”, takes upper “16” bits when the importance degree is “middle” and takes upper “8” bits when the importance degree is “low” respectively to apply the taken filter coefficients h′(0) to h′(N-1) to the operator 25.

The operator 25 performs an operation of following equation (2) to output the audio signal “A” whose alias is removed by using all of the “119” data x′(n−1) to x′(n−119) stored in the delaying buffer 22 and the n-th data x(n) and the “120” filter coefficients h′(0) to h′(N−1) regardless of the importance degree.

$$y ( n ) = {\sum }_{i = 0}^{119} {h}^{′} ( i ) \cdot {x}^{′} ( n - 1 ) \qquad ( 2 )$$

The FIR filter 12 of FIG. 3 switches the number of the taps according to the importance degree, while the number of the taps used by the FIR filter 12a of the present embodiment is constant, namely, “120” independent of the importance degree.

As the importance degree is higher, the FIR filter 12a performs filtering processing with the larger number of the bits of the audio signal, thereby improving the frequency-converted sound quality. On the other hand, as the importance degree is lower, the FIR filter 12a performs filtering processing with the smaller number of the bits of the audio signal, thereby reducing the amount of the operations and performing frequency conversion with the low sound quality and the low power consumption.

As stated above, in the second embodiment, the frequency conversion is performed by switching the number of the bits of the audio signals according to the importance degree. Therefore, as well as the first embodiment, when a plurality of audio signals are mixed to be reproduced at the same time, the sound quality of well-heard audio signal is kept high and the power consumption of the entire of the audio reproduce device can be reduced.

Note that only one of the first and the second bit taking modules 26 and 27 can be provided, and the number of one of the audio signal and the filter coefficient can be switched according to the importance degree. Furthermore, FIG. 3 and FIG. 9 can be combined. That is, the first and the second bit taking modules 26 and 27 can be further provided in the FIR filter 12 of FIG. 3 to switch both of the number of taps and the number of bits.

### Third Embodiment

The first and the second embodiments take it consideration to input a plurality of audio signals. However, a third embodiment explained below relates to an audio playback device having one input audio signal.

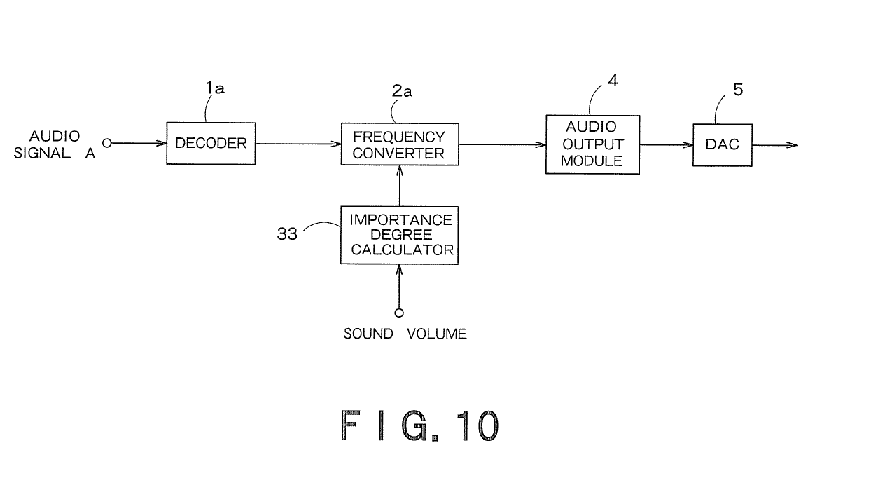

FIG. 10 is a block diagram showing a schematic configuration of an audio playback device according to the third embodiment of the present invention. In FIG. 10, components common to those of FIG. 1 have common reference numerals, respectively. Hereinafter, components different from FIG. 1 will be mainly described below.

An audio signal is inputted to the audio playback device of FIG. 10. In this case, the plurality of audio signals are not mixed different from FIG. 1. However, the frequency conversion may be performed when the DAC 5 receives only a specific frequency or the like. Therefore, the audio playback device of FIG. 10 has a frequency converter 2a. Furthermore, although the mixer 3 is unnecessary because the number of the inputted audio signals is one, the audio playback device has the importance degree calculator 33.

The importance degree calculator 33 sets the importance degree according to the playback sound volume of the audio signal “A” to inform the frequency converter 2a of the importance degree. Furthermore, the importance degree calculator 33 can set the importance degree in consideration of the operation mode. The configuration of the FIR filter 12 in the frequency converter 2a is shown in FIG. 3 or FIG. 9, for example. When the importance degree is high, the FIR filter 12 performs frequency conversion with the high sound quality and when the importance degree is low, the FIR filter 12 performs frequency conversion with the low power consumption.

As stated above, in the third embodiment, the way of frequency conversion is switched according to the sound volume even though the number of the inputted audio signal is one. Therefore, when the sound volume is large, the audio signal is reproduced with high sound quality, and when the sound volume is small, the power consumption of the audio playback device can be reduced.

At least a part of the audio playback device explained in the above embodiments can be formed of hardware or software. When the audio playback device is partially formed of the software, it is possible to store a program implementing at least a partial function of the audio playback device in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the audio playback device can be distributed through a communication line (including radio communication) such as the Internet etc. Furthermore, the program which is encrypted, modulated, or compressed can be distributed through a wired line or a radio link such as the Internet etc. or through the recording medium storing the program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An audio playback device comprising:
an importance degree calculator configured to set an importance degree of a digital audio signal based on a playback sound volume of the digital audio signal; and
a frequency converter configured to convert a sampling frequency of the digital audio signal to a predetermined frequency with sound quality and power consumption according to the importance degree.

2. The device of claim 1, wherein the frequency converter converts the sampling frequency of the digital audio signal to the predetermined frequency with lower sound quality and lower power consumption as the importance degree is lower and converts with higher sound quality as the importance degree is higher.

3. The device of claim 1, wherein the importance degree calculator sets the importance degree further in consideration of an operation mode defining the power consumption of the audio playback device.

4. The device of claim 1, wherein the frequency converter comprises a plurality of delaying modules connected in series which is configured to delay the digital audio signal to store a plurality of data of the digital audio signal,
wherein the frequency converter converts the sampling frequency of the digital audio signal to the predetermined frequency using a larger number of the data stored in the delaying modules among the data of the digital audio signal stored in the delaying modules as the importance degree is higher.

5. The device of claim 1, wherein the frequency converter comprises:
a plurality of delaying modules connected in series which is configured to delay the digital audio signal to store a plurality of data of the digital audio signal;
a data selector configured to selects a first number of data among the plurality of data of the digital audio signal stored in the delaying modules, the first number being depending on the importance degree;
a coefficient selector configured to select the first number of filter coefficients;
a plurality of multipliers configured to multiply the selected data by the selected filter coefficients; and
an adder configured to adds outputs of the plurality of multipliers.

6. The device of claim 1, wherein the frequency converter converts the sampling frequency of the digital audio signal to the predetermined frequency using a larger number of bits of at least one of the digital audio signal and filter coefficient used for low pass filter processing as the importance degree is higher.

7. The device of claim 1, wherein the frequency converter comprises:
a bit taking module configured to take upper bits of the digital audio signal according to the importance degree;
a plurality of delaying modules connected in series which is configured to delay the taken upper bits of the digital audio signal to store a plurality of taken upper bits of the data of the digital audio signal;
a plurality of multiplier configured to multiply the plurality of taken upper bits of the data of the digital audio signal by filter coefficients used for low pass filter processing corresponding to the plurality of data of the digital audio signal; and
an adder configured to adds outputs of the plurality of multipliers.

8. The device of claim 1, wherein the frequency converter comprises:
a plurality of delaying modules connected in series which is configured to delay the digital audio signal to store a plurality of data of the digital audio signal;
a bit taking module configured to take upper bits of filter coefficient used for low pass filter processing corresponding to the plurality of data of the digital audio signal according to the importance degree;
a plurality of multiplier configured to multiply the plurality of data of the digital audio signal by the taken upper bits of the filter coefficients; and
an adder configured to adds outputs of the plurality of multipliers.

9. An audio playback device comprising:
a plurality of importance degree calculators corresponding to a plurality of digital audio signals each of which is configured to set an importance degree of each of the plurality of digital audio signals based on a playback sound volume of each of the plurality of digital audio signals and a number of the plurality of digital audio signals; and
a plurality of frequency converters corresponding to the plurality of digital audio signals each of which is configured to convert a sampling frequency of corresponding one of the plurality of digital audio signals to a predetermined frequency with sound quality and power consumption according to the importance degree.

10. The device of claim 9, wherein the frequency converter converts the sampling frequency of the digital audio signal to the predetermined frequency with lower sound quality and lower power consumption as the importance degree is lower and converts with higher sound quality as the importance degree is higher.

11. The device of claim 9 further comprising an adder configured to mix the plurality of digital audio signals whose sampling frequencies are converted to the predetermined frequency with a ratio according to the playback sound volume.

12. The device of claim 9, wherein the importance degree calculator sets the importance degree further in consideration of an operation mode defining the power consumption of the audio playback device.

13. The device of claim 9, wherein the frequency converter comprises a plurality of delaying modules connected in series which is configured to delay the digital audio signal to store a plurality of data of the digital audio signal,
wherein the frequency converter converts the sampling frequency of the digital audio signal to the predetermined frequency using a larger number of the data stored in the delaying modules among the data of the digital audio signal stored in the delaying modules as the importance degree is higher.

14. The device of claim 9, wherein the frequency converter comprises:
a plurality of delaying modules connected in series which is configured to delay the digital audio signal to store a plurality of data of the digital audio signal;
a data selector configured to selects a first number of data among the plurality of data of the digital audio signal stored in the delaying modules, the first number being depending on the importance degree;
a coefficient selector configured to select the first number of filter coefficients;
a plurality of multipliers configured to multiply the selected data by the selected filter coefficients; and
an adder configured to adds outputs of the plurality of multipliers.

15. The device of claim 9, wherein the frequency converter converts the sampling frequency of the digital audio signal to the predetermined frequency using a larger number of bits of at least one of the digital audio signal and filter coefficient used for low pass filter processing as the importance degree is higher.

16. The device of claim 9, wherein the frequency converter comprises:
a bit taking module configured to take upper bits of the digital audio signal according to the importance degree;
a plurality of delaying modules connected in series which is configured to delay the taken upper bits of the digital audio signal to store a plurality of taken upper bits of the data of the digital audio signal;
a plurality of multiplier configured to multiply the plurality of taken upper bits of the data of the digital audio signal by filter coefficients used for low pass filter processing corresponding to the plurality of data of the digital audio signal; and
an adder configured to adds outputs of the plurality of multipliers.

17. The device of claim 9, wherein the frequency converter comprises:
a plurality of delaying modules connected in series which is configured to delay the digital audio signal to store a plurality of data of the digital audio signal;
a bit taking module configured to take upper bits of filter coefficient used for low pass filter processing corresponding to the plurality of data of the digital audio signal according to the importance degree;
a plurality of multiplier configured to multiply the plurality of data of the digital audio signal by the taken upper bits of the filter coefficients; and
an adder configured to adds outputs of the plurality of multipliers.

18. An audio playback method comprising:
setting an importance degree of a digital audio signal based on a playback sound volume of the digital audio signal; and
converting a sampling frequency of the digital audio signal to a predetermined frequency with sound quality and power consumption according to the importance degree.

19. The method of claim 18, wherein upon converting the sampling frequency to the predetermined frequency, the sampling frequency is converted to the predetermined frequency with lower sound quality and lower power consumption as the importance degree is lower and converted with higher sound quality as the importance degree is higher.

20. The method of claim 18, wherein upon setting the importance degree, the importance degree is set further in consideration of an operation mode defining a power consumption of an audio playback device.
